(19) United States
(12) Patent Application Publication
(10) Pub. No.: US 2005/0060663 A1
(43) Pub. Date: Mar. 17, 2005

(54) Enhanced task manager for active process management

(75) Inventors: Woodrow Wyatt Arkeketa, Austin, TX (US); Vijaylaxmi Chakravarty, Austin, TX (US); Shengdong Chen, Cedar Park, TX (US)

Correspondence Address: BRACEWELL & PATTERSON, L.L.P., P.O. BOX 969, AUSTIN, TX, 78767-0969, US

(73) Assignee: International Business Machines Corporation, Armonk, NY (US)

(21) Appl. No.: 10/651,169

(22) Filed: Aug. 28, 2003

(51) Int. Cl. G06F 3/00

(52) U.S. Cl. 715/810

(57) ABSTRACT

A method and system that enhances the functionality of a Task Manager with the capability to obtain and display information about specific services associated with a particular executable as well as the capability of obtaining and displaying information about what parameters have been utilized to launch an executable. The system user is provided with a single display by which to manage active programs/processes. Additionally, the user is able to quickly determine what the active programs are being utilized for, to locate the executable, and to see associated system usage attributes.

### BACKGROUND OF THE INVENTION

1. Technical Field

The present invention relates generally to computer systems and in particular to management features for processes executing on computer systems. Still more particularly, the present invention relates to a method and system for providing more specific information about services and other information relevant to a process executing on a computer system.

2. Description of the Related Art

Computer systems are designed/built with a limited amount of processor, memory, and other hardware resources. During operation, the processor(s) of the computer system executes one or more program applications along with the operating system (OS), and these program applications (and the OS) require memory space to execute.

Most current computer systems enable concurrent/overlapping execution of multiple applications, tasks, services, and/or processes (collectively referred to as processes). These processors each utilize a portion of the available resources of the computer system and typically operate independent of all other processes running on the computer system (i.e., they can be started and stopped without affecting other processes). Because of the limited amount of available processor and memory resources being shared amongst the various processes that are running on the computer system, it is useful to be able to track the level/amount of use by each process of the specific resources of the computer system.

The tracking of resource usage by the executing processes on the computer system is a function provided by most current operating systems. For example, in Microsoft's Windows NT®, Windows 2000®, and Windows XP® operating systems, a Task Manager is provided. The Task Manager is a user interface that provides a list of all active processes and associated system usage attributes. The system usage attributes informs the user about the amount/level of memory and CPU resources being utilized by particular processes executing on the system.

FIG. 1 illustrates a typical Task Manager interface. As illustrated, Task Manager 101 provides/displays several columns of information including a list of executing processes identified by the image name 102 of the executable file and a process identifier (PID) 103. Also provided are CPU usage time 104, and memory usage 106 associated with that process. The opened window 108 for a selected process (svchost.exe) displays several options including, the “End Process”, “End Process Tree”, “Debug” , and “Set Priority” options. At the bottom of the window is an end process button 109 by which a selected process can be terminated by a user. The end process operation is typically utilized when a problem is encountered and that problem is identified as being connected to a particular process. However, these options are typically not usable by a process that contains background services; hence, ending the process cannot be done from within the Task Manager.

Active processes (or executables) that are displayed in Task Manager 101 can be grouped into Service and non-Service processes. That is, some processes may be linked to one or more services executing in the background, while other processes may not contain a background service. Within Task Manager 101, the actual services associated with a process are hidden and often have a very different name and functionality than the displayed process name. The name of the executable itself is therefore not indicative of the service being run by that executable and it is common to have the same executable (name) appear multiple times in the Task manager. This typically occurs when the same executable is launched at different times and/or launched using different parameters/services.

Thus, while providing some useful information about the system and the resource usage, several limitations exist within the current implementation of Task Manager 101. For example, with certain types of processes, the Task Manager does not provide sufficient information about the actual services that are executing and what resources are being utilized by the particular services. When a service associated with the process is causing a memory leak or a run on the memory or processor resources, there is currently no way to quickly determining which particular service is responsible for the problem since the process is usually not identified by the display names of the services and the individual services are not listed. Typically, the only way to make such a determination is by stopping the service (i.e., usually the process itself) from executing, checking to see if the problem is resolved, and then restarting the background service at a later time. However, Task Manager does not currently allow a user to stop a service that is executing, and the user has to open a separate Services Window from within the Control Panel to locate and then stop the service. FIG. 1B illustrates a Services Window 121 displaying the complete set of executing services 123, which are each associated with a process displayed within Task Manager 101. With one executable having several services associated with it, having the process ID (PID) and process name is not sufficient for identifying a specific underlying service that may be causing a problem. Also, with multiple services associated with a single process, this is inefficient and does not really resolve the question of which specific service was responsible. For example, when computer resources are being bogged down by an identified “process,” it is useful to be able to identify the actual service(s) that may be responsible for the problem and close (and perhaps re-open) that particular service.

One currently available software, WinTasks 4 Professional, extends the features of the Task Manager to show the full paths of the active processes and the description of the processes. However, there is still no capability of the Task Manager or WinTask 4 Professional to obtain information about which service is associated with a particular executable and what parameters have been used to launch a service.

Currently, Windows allows a user to access a list of active services within the Services window to check on the parameters and attributes of the services. However, the Services window is separate from the Task Manager and does not share any functional overlap with the Task Manager. The Services Window also provides a complete list of all the services executing on the system. However, the user has no easy way to find out which services are associated with a specific PID.

The Windows SDK or Resource Kit provides a services query function that can be used to search for the PID. For example, the SC query (sc queryex type=service bufsize=7000) returns with a list of all the active services with their respective display name, service name, PID, and other relative data. Once the service display names are determined for a specific PID, the relationship between Task Manager PID and the Services window service display name can be seen. The user is then able to stop specific services within the Services window from executing.

The present invention recognizes the limitations of the Task Manager even with the enhancement provided by WinTasks™ 4 Professional, and the invention provides a method and system for efficiently providing an output of the background services associated with executing processes displayed within the Task Manager. The present invention also realizes that it would be desirable to provide a method and system for providing more complete information about the actual services and/or tasks executing on a computer system. A method by which the functionality of the Task Manager is extended to provide information about which service is associated with a particular executable and what parameters have been used to launch the background service along with other properties of the service would be a welcomed improvement. These and other benefits are provided by the invention described herein.

### SUMMARY OF THE INVENTION

Disclosed is a method and system that enhances the functionality of a Task Manager with the capability to obtain and display information about specific services associated with a particular process. The invention also provides the capability of obtaining and displaying information about a service such as the path of the executable and what parameters were utilized to launch the service. The method and system of the invention provides the user with a single window display by which to manage the background services of active processes. Additionally, the user is able to quickly determine what the actual services are, location of the executable for the service, etc. Finally, the user is provided with the ability to quickly stop (and restart) specific services that may be causing problems within the system.

In one embodiment, the Task Manager is enhanced with additional services utility code. The services utility code adds a services option to the child window that opens when a process that has underlying services is selected (or highlighted) by a user. Selection of the services option then opens a Services Window that contains only those services associated with the process. This provides an established user interface tailored to the process and its related services. In another embodiment, the same selection provides a services child window that displays a list (names) of background services associated with the particular process. Since a particular executable (with a particular PID) may include multiple different services, the invention enables the user to see which specific services within the process are utilizing the system resources. Also, in either embodiment, selection (highlighting) by the user of one of the displayed services provides a properties window with specific parameters/attributes of the selected service as would be provided if the properties option was selected from the Services window. Among these parameters/attributes are display name, description, path to service executable, etc. The properties window is also an already established user interface and should be maintained.

In another implementation, the services utility is separate from the Task Manager and is accessed by a separate window. The PID is entered by the user into this window, and the window provides an output of the list of executing services by either of the 2 above identified embodiments. That is, selection of one of the services provides a properties window with the parameters/attributes of the service. According to one embodiment, the user is able to open a separate query window provided by the services utility. With this implementation, the service utility may be packaged on its own as an add-on to an existing OS with Task Manager functionality.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1A depicts a graphical user interface (GUI) of a Windows' Task Manager application displaying a list of executing processes according to the prior art;

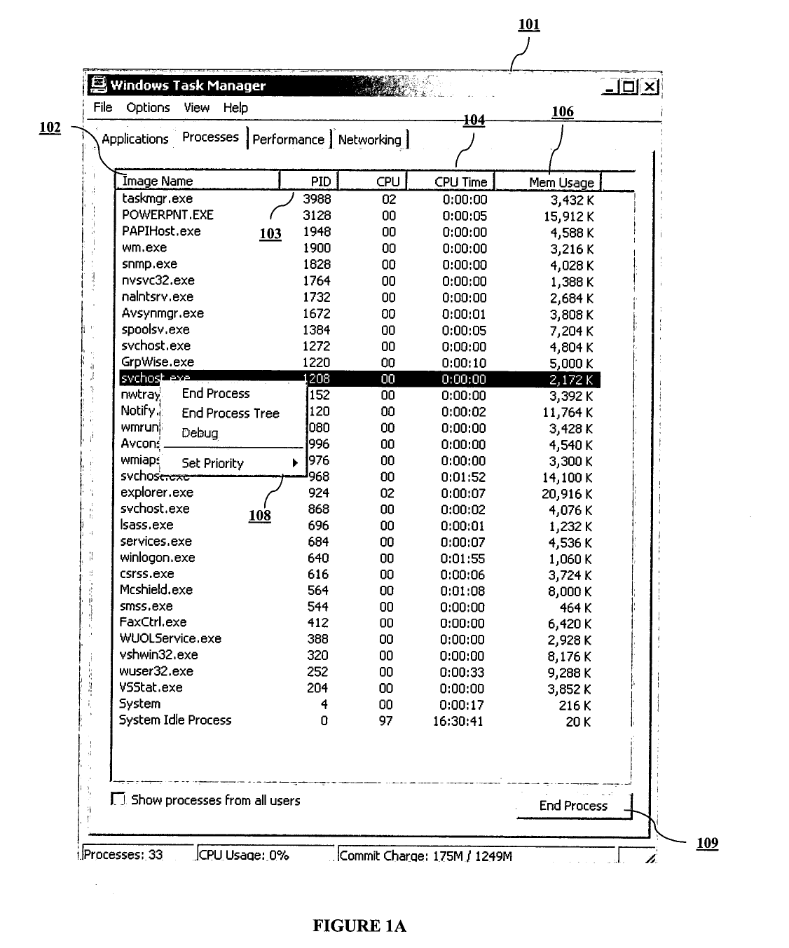

FIG. 1B depicts a graphical user interface (GUI) of a Services Window application displaying the list of executing services according to the prior art;

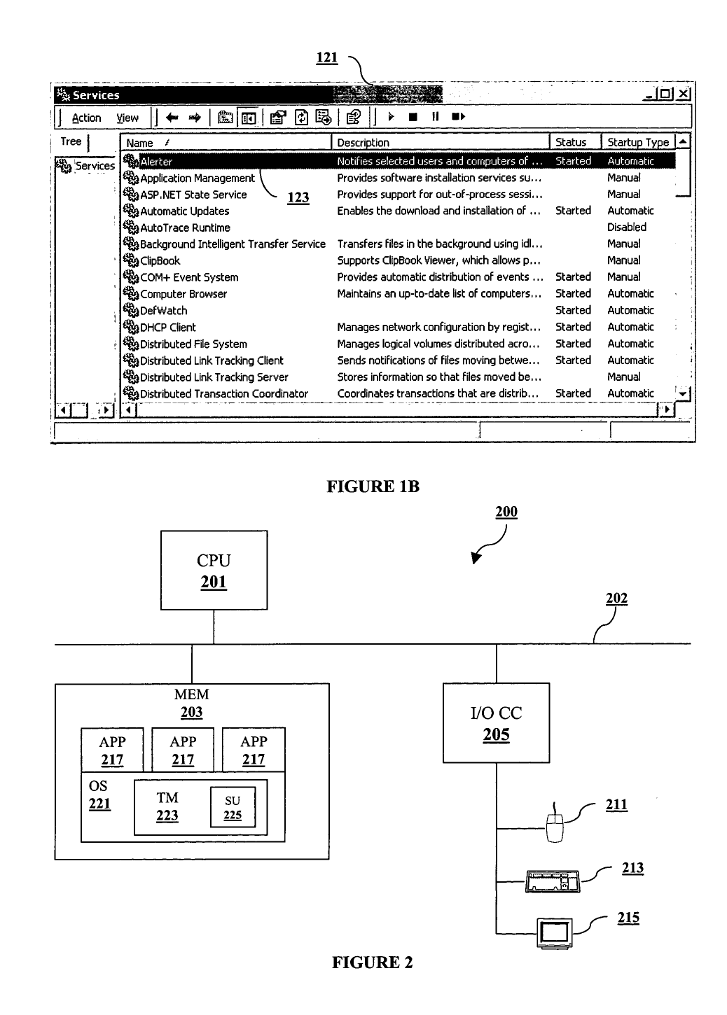

FIG. 2 is a block diagram illustrating major hardware and software components of a computer system according to one implementation of the invention;

FIG. 3A depicts a GUI of a Task Manager application displaying a list of executing processes along with a selectable option for identifying specific services according to one implementation of the invention;

FIG. 3B depicts a GUI of the Task Manager application of FIG. 3A with a child GUI displaying names of the background services associated with a selected process and properties window of a selected background service according to one embodiment of the invention;

FIG. 3C depicts a GUI of the Task Manager application of FIG. 3A with the actual Services Window displaying the specific ones of executing services associated with the selected process according to another embodiment of the invention;

FIG. 3D illustrates a properties GUI that is provided for a selected service according to one embodiment of the invention;

FIG. 4A is a flow chart of one process of accessing the services option from the enhanced Task Manager during system usage in accordance with two embodiments of the invention;

FIG. 4B is a flow diagram of the user-interaction for obtaining services information from executing processes within the Task Manager according to two embodiments of the invention;

FIGS. 5A-5D are block diagrams illustrating the non-integrated implementation of a services utility according to various embodiments of the invention; and

FIG. 5E is a flow chart of the process of completing the services check via the non-integrated implementation according to the non-integrated embodiments of the invention.

### DETAILED DESCRIPTION OF ILLUSTRATIVE EMBODIMENT(S)

The present invention provides an enhanced task manager functionality by which a user is able to view the list of background service(s) and other important attributes of the service(s) previously identified only by an associated process name and process identifier (PID). The invention provides the user with the additional information such as the resource usage for the specific service, in a relatively easy way so that the user is able to obtain more relevant information about a process. With this information the user is able to decide what to do with a particular executing process that may be identified as the source of a problem without the user having to end all of the services associated with that process.

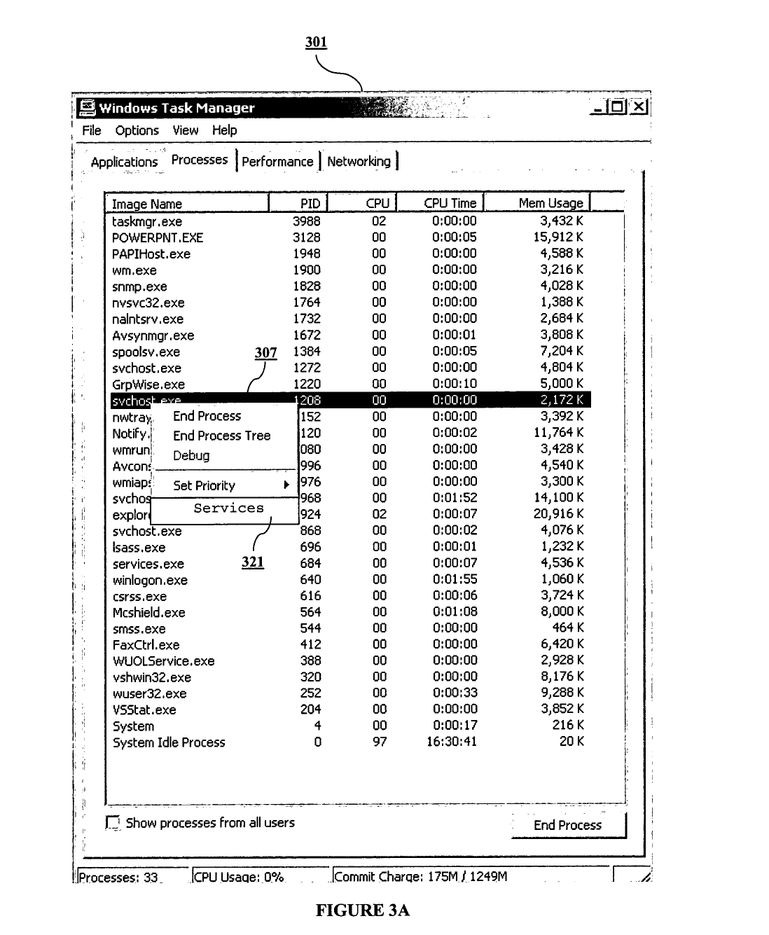

With reference now to the figures, and in particular with reference to FIG. 2, there is illustrated a block diagram representation of a data processing system (DPS) within which various features of the present invention may advantageously be implemented. DPS 200 comprises central processing unit (CPU) 201 coupled to memory 203 and input/output (I/O) channel controller (I/O CC) 205 via interconnect (or system bus) 202.

I/O controller 205 provides connectivity and control for I/O devices, including, for example, mouse 211, keyboard 213, and monitor 215. I/O devices are collectively utilized to complete the various manipulation of software and/or the display of application windows, such as Task Manager, as described below. Specifically, a Task Manager graphical user interface (GUI) and a services child window are displayed to a user via monitor 215 and user interaction with these software graphical components are completed utilizing mouse 211 and/or keyboard 213.

In addition to the hardware components described above (and others that are not specifically shown), DPS 200 comprises various software programs/applications, which are illustrated as being primarily stored in memory 203. Among these applications are operating system (OS) 221, which, in the illustrative embodiment, includes Task Manager 223 and services utility 225. Additional applications 217 are also provided within DPS 200. The execution of these applications 217 by the processor 201 and associated usage of memory and processor resources are tracked by Task Manager 223 (and services utility 225).

In the illustrative embodiment, and according to the described embodiment, Task Manager 223 exist as a component part of OS 221, and Task Manager 223 includes (or is associated with) additional service tracking functionality (i.e., service utility 225) that may be implemented as a functional addition within Task Manager 223. However, in other embodiments, the new features of the invention are implemented as a separate application/utility (services utility 225) that is not necessarily affiliated/tied to Task Manager 223.

Two distinct implementations of the invention are possible. The first implementation is referred to herein as the integrated implementation, while the second implementation is referred to as the non-integrated implementation. In the integrated implementation, the functionality of the invention is provided as an integral part of the Task Manager. That is, the Task manager code includes the code for implementing the services utility options within the Task Manager itself and providing all other features within the Task Manager. The non-integrated implementation requires the user to obtain the process ID from the Task Manager's Processes window and enter the PID in a separate GUI/window that initiates the services utility features of the invention.

Thus, the invention provides two main implementations; however, each implementation comprises different embodiments. These embodiments include: (1) adding a services menu item to a Task Manager process which enables the list of associated services to be displayed either by (a) the Services Window, an already established user interface, or (b) a new services list window to list only display names of services associated with the PID; and (2) the utility: (a) used to allow a PID as input to resolve the service display names, if any, allowing the user to work with services associated with the PID in the same manner described in (1a) and (1b) above; or (b) to use the list with the existing Services Window that shows all the active services (this is the least desirable, but is the easiest to implement).

Integrated Services Utility

Thus, the integrated embodiment of the invention implements an enhanced Task Manager, which, in addition to the standard features provides the following information for all active processes: (1) an indication of whether or not the process comprises one or more services, including the name of the services, if any; (2) the ability to see the service properties window that is available via the Services window or a new list window showing the services associated with the process; and (3) the ability to utilize all functions available via the properties window from the Task Manager (for example, stopping a service).

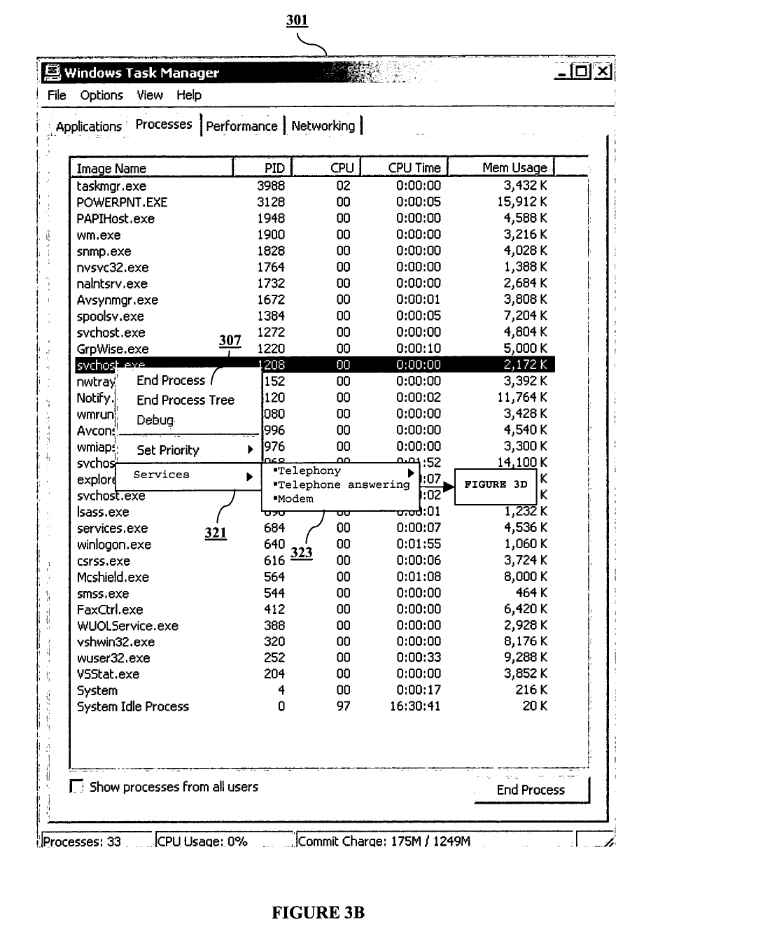

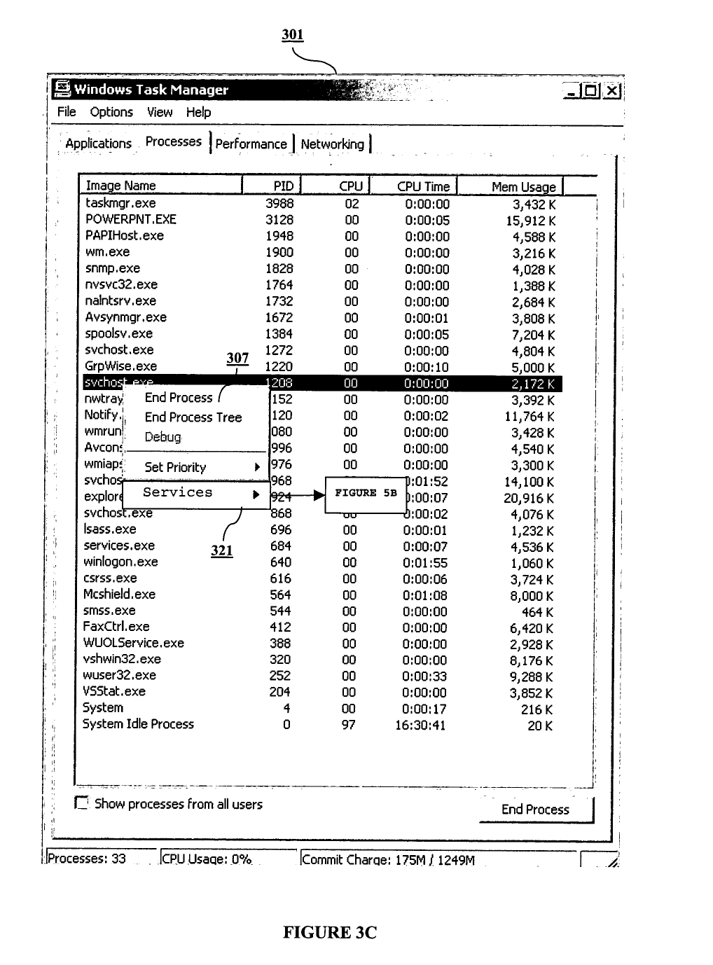

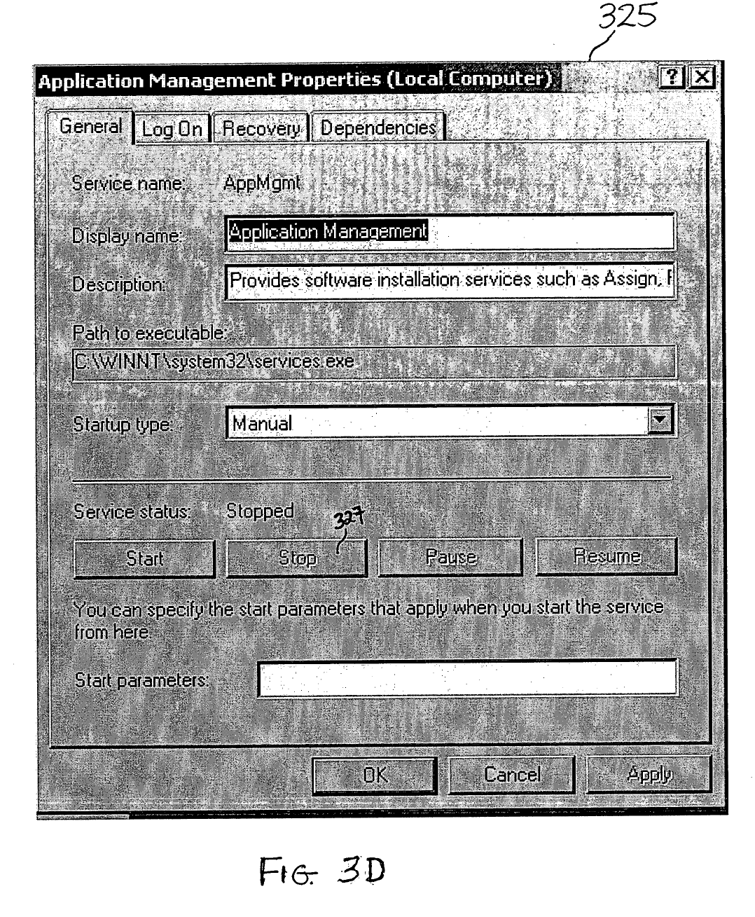

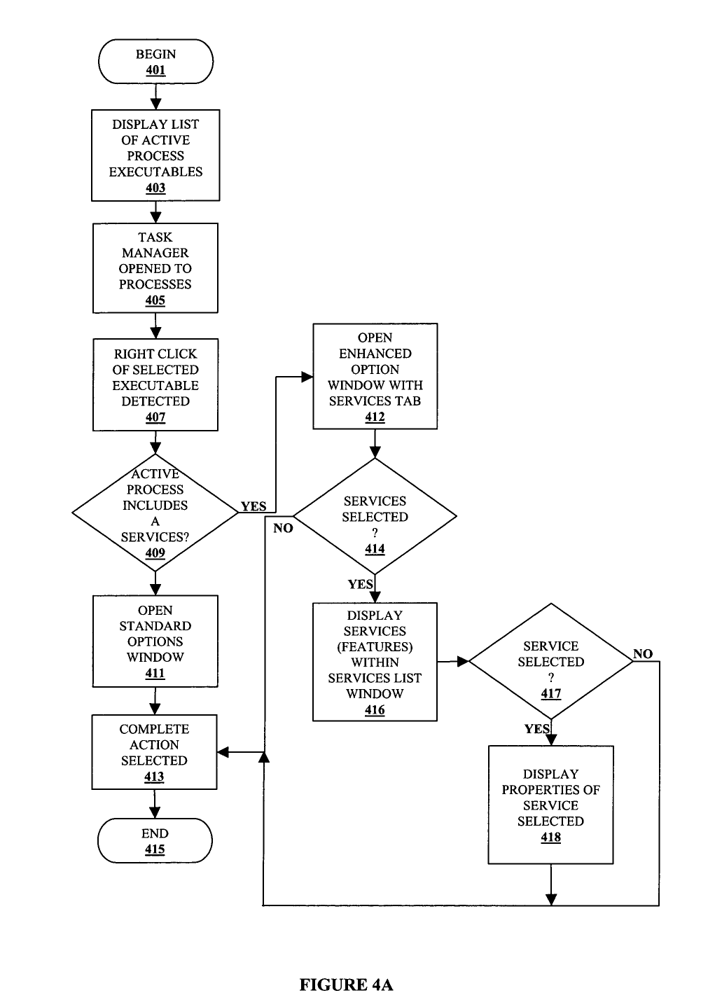

In one embodiment, illustrated in FIGS. 3A-3C, a “Services” option is added within the pull down menu 307 of available options for a selected process. The services option 321 is utilized to access the above listed information as described below.

FIG. 3A depicts the processes interfaces of an enhanced Task Manager 301 according to one implementation. Task Manager 301 is displayed with a list of processes (or executables) and standard process identifiers (PIDs) and resources usage information. Selection of one of the processes by moving a mouse over the process (e.g., svchost.exe) and right clicking on that process opens a child window 307, within which several options are provided. Among these options are the traditional “End Process,” “End Process Tree,” “Debug,” and “Set Priority” items. One additional option, called “Services,” is also provided. The services option 321 provides the user with a user-selectable option for displaying the service display names associated with the process. The services option 321 is automatically disabled (e.g., not highlighted within the pull down menu 307 of options) if there is no service associated with the selected process. When the information is available, i.e., there are background services associated with the selected process, the services option 321 is enabled, and selection of the “services” option 321 initiated a background checking of open services with that PID, and generates a display window (referred to herein as services list window 323), which lists the service display names of the services.

Thus, only those processes that have at least one associated service provides a selectable services option 321 when the process is selected. For example (and as illustrated), when the process named svchost.exe with an associated service is selected by the user, the services option 321 automatically becomes available within child window 307. In one alternate embodiment, other processes that have no associated services, etc. do not display this option within child window 307. In the illustrated embodiment, the services option is always displayed but is only highlighted as a selectable option when the process actually has an associated service. Thus, child window 307 is dynamically configured to display or not display the “services” option for a selected process.

FIGS. 3B and 3C illustrates two implementations of the features associated with the enhanced Task Manager of FIG. 3A. As indicated, the Task Manager 301 is enhanced to provide additional services information in child windows or to open the Service Window. When there are one or more services sharing a single executable, the invention enables the user to quickly find out which service(s) are associated with the particular executable. For example, as shown in FIG. 3B, multiple different services may be running under the svchost.exe executable with PID of 1208. For illustrative purposes, four services are shown executing under svchost.exe with PID 1208, Telephone, Telephony, Telephone Answering, and Modem. These named services are provided solely for illustration and not intended to limit the scope of the invention. Thus, as illustrated by FIG. 3B, a user is able to quickly ascertain which services are being run by the particular executable using the enhancements provided by the invention. Services list window 323 lists these services by their display names so that a user may easily determine which services are running.

Selecting a service display name in FIG. 3B allows the properties window 325 of FIG. 3D to be displayed. Thus, selection of the service within the services list window 323 opens the actual properties window 325 as would selection within the Services window 521, as further described below.

FIG. 3C illustrates the embodiment in which selection of services option 321 actual provides the Services window 521, rather than a child window (i.e., services list window 323) with the specific subset of services linked to the particular PID of the selected process. Services window 521 provides a list of the executing services 523; However, unlike services list window 323, which only displays the names of the services, services window 521 also displays a description, status, and start-up type of the executing services. Additionally, several tabs are provided within Services Windows and these tabs may be selected to provide additional features. As with FIG. 3B, the user is then able to select a service from within services window 521 and open up the actual properties window 325 illustrated by FIG. 3D. Thus, for both implementations, the user is provided the same user interface (i.e., properties window 325) that allows a service to be started and stopped from within services window 521.

This latter embodiment is particularly useful when the user is attempting to debug a problem that causes a drain on system resources, etc. or causes the process/executable to show up as utilizing too much resources. When a process resource usage information indicates a problem one or more of the service can be stopped until the problem is resolved.

Once the list of services is provided within services list window 323, the user is then able to select one of the services, e.g., Telephony, and open up a second level child window, referred to herein as properties window 325. Properties window 325 provides information about the selected service.

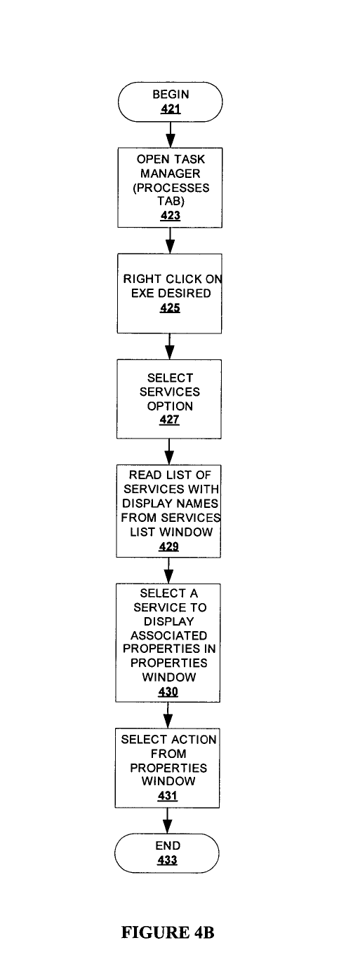

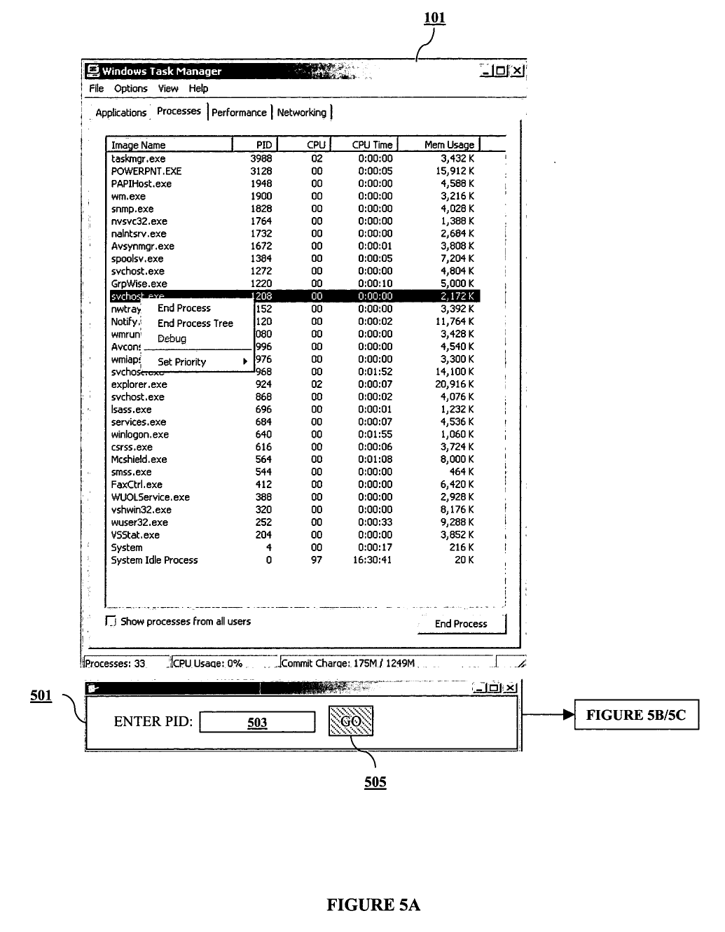

With reference now to FIG. 4A, there is illustrated a process flow chart by which the system execution of the features of the invention within the Task Manager are implemented. The process begins at block 401 and proceeds to block 403, which depicts the opening of Task Manager to the processes tab. The list of active processes (i.e., executables) are displayed within Task Manager as shown at block 405. The Task Manager application monitors for and registers a right click on a selected process as indicated at block 407. A determination is made at block 409, whether the selected process actually has an affiliated background service. If the process does not have any background services, the standard options child window is opened as shown at block 411, and then the action selected from within the standard options child window is completed as shown at block 413. Then, the process ends at block 415.

Returning to decision block 409, if the process does have an affiliated background service, an enhanced options child window is opened as shown at block 412. The enhanced options child window includes a selectable services option. A determination is then made at block 414 whether the services option is selected. If not, the action affiliated with one of the other standard options selected is implemented (or the window is closed). If the services option is selected, the service display names affiliated with the process are listed within the services list window 323 (or services window 521) as shown at block 416. A determination is then made as indicated at block 417 whether a service name is selected by the user. If no service name is selected, then the process passes to block 413. If a service display name is selected, however, the properties window 325 is displayed as indicated at block 418. Once in the properties window the user can manipulate the service in an already established user interface. When done, processing returns back to block 413.

FIG. 4B provides a process flow from a user's perspective when the user is interacting with the enhanced Task Manager. The process begins at block 421 and proceeds to block 423, which depicts the user opening the Task Manager application on his computer system to the processes tab. The user then selects one of the processes using an I/O device as shown at block 425. In the described embodiment, a mouse is utilized and the user right clicks on the process for which the user desires the additional information. When the selection by the user is received, the options window opens with a display of the selectable options, including a services option. Selection of the services option by the user as shown at block 427 opens up the services list window within which the user is able to view the name(s) of the affiliated background service(s) as indicated at block 429. Selecting a service, the user is then able to view the services properties window 325, as shown at block 430, and the user is able to work with the properties window just as if it had been access via the Services window 521 as indicated at block 431. The process flow then ends as shown at block 433.

The user is able to easily get services information (i.e., whether the executable is associated with a service) from implementations of the invention. Unlike other software implementation, which only shows the process associated with a particular service, the invention also provides a method to show the service associated with a particular process (or executable) as well as the additional features described herein.

Non-Integrated Services Utility

In one implementation, the Task Manager itself is not changed. Rather, the functionality of the invention is achieved by locating the image name and PID (process ID) in the task manager, which are then passed to a command line utility (i.e., services utility) that ultimately provides the remainder of the features discussed above.

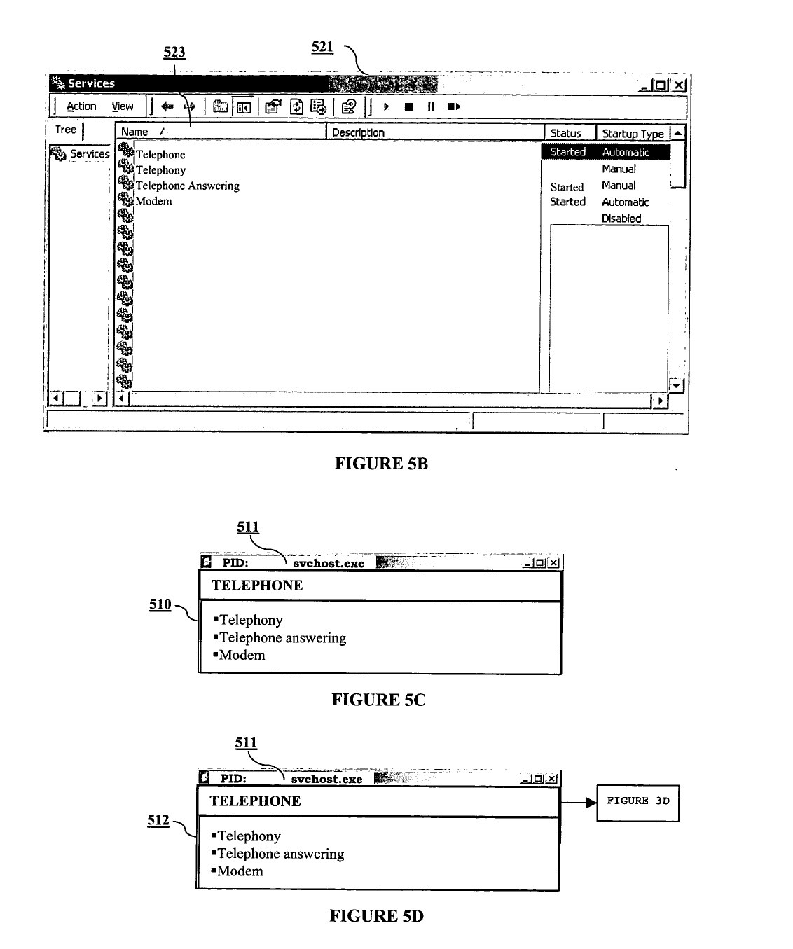

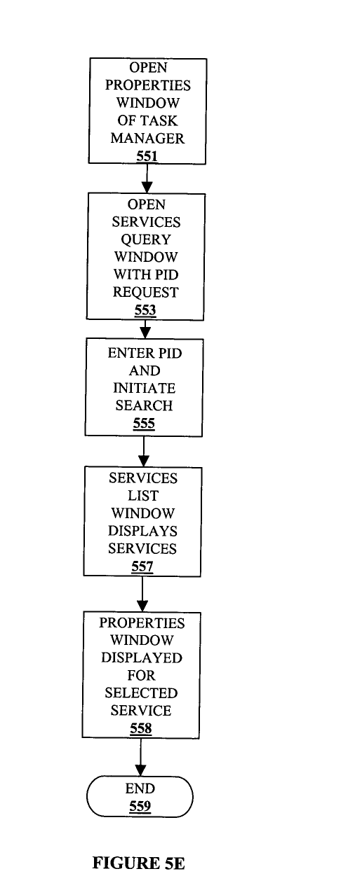

With reference now to FIG. 5A, viewable Processes window of Task Manager 101 is configured similarly to current implementations with the executable name and process ID (PID), etc. Additionally, a separate services query window 501 is provided with an input bar 503 in which the PID of the process being queried is entered to initiate the steps of finding the services, etc. The services query window 501 may be opened by the user having identified the particular process he wishes to query from the Task Manager. The user may decide to open the services query window after the user unsuccessfully attempts to stop a process from within Task manager 101 when that process has an affiliated service.

In one embodiment, the services utility is invoked when the user selects the “Go” button 505 with the PID entered. Selection of the “Go” button 505 provides the PID as the object of a SC Query command line in the background. Also, according to the illustrative embodiment of FIG. 5B, the services window 521 is opened by the user when “Go” button 505 is selected, displaying the list of services associated with the process/PID. FIG. 5B illustrates the services window 521 with various functional features described above.

In another embodiment illustrated by FIG. 5C, when the user enters the PID in the input bar 503 and selects go button 505, the background query is initiated and the query returns a services list window 510 in which the user is simply provided with the service display names associated with the PID entered. This list of service names enables the service(s) to be quickly and easily identified and/or located within the services window 121, which is also opened by the user and which displays a list of all executing services. This feature of the invention evolves from a recognition that it would be advantageous for the service display name be provided so that it could be easily found in the Services window 121 should the user wish to use that interface to manage the services.

Services list window 510 contains a similar listing of the display names of the associated services as provided in services list window 323 of the integrated embodiment. However, with this non-integrated implementation, since the process name and affiliated PID are not necessarily highlighted in Task Manager 101 when the services list window 510 is returned, that information (i.e., PID) is mirrored in window label 511 of services list window 510.

FIG. 5D provides different embodiment, which displays services list window 512 populated with selectable services in the service list. As with the integrated embodiment, selection of a particular service from within services list window 512 or service window 323 generates a corresponding properties window 325, which contains relevant parameters/attributes of the selected service as described above (i.e., properties window 325 of FIG. 3D).

FIG. 5E provides a flow chart of the steps involved in the process when utilizing the non-integrated embodiment. The user opens the Task Manager to the properties tab as indicated at block 551. Responsive to the displaying of the list of properties (i.e., the automatic or user-initiated selection of the properties tab), the services query window opens up (or is displayed) on the user's monitor as shown at block 553. In another implementation, the user actually opens the services query window himself when the user desires to stop a process that is listed with a PID within Task manager and which contains a background service (i.e., the process cannot be stopped from the Task manager). Then the PID is entered by the user and a search for associated services is initiated at block 555. Following, as shown at block 557, the services window is displayed with a list of the associated services. Then, the properties window of a selected service is displayed as indicated at block 558. The process then ends, as indicated at block 559.

According to another implementation of the invention, the PID is utilized within the “sc queryex” command of Windows to find all the services that are active under the particular PID. The output from this query/search is then parsed, and a list of applicable services is built. The list of applicable services also indicates whether the service is stoppable or not and in the described embodiment, the service description is also provided. This feature may be provided within Task Manager or within the separate services utility that may or may not be affiliated with the Task Manager.

The invention may be implemented within the standard operating system (OS) such as Microsoft's Windows NT, Windows 2000, and Windows XP Operating Systems. However, as described above, embodiments are provided by which the features of the invention are made available as a separate service utility. With this alternate embodiment, the invention provides a user, whose computer system includes a standard Windows OS with the option of installing the service utility to enhance the Task Manager of the OS to provide the user with access to significantly more information about a process, along with resources that are being utilized by the process than would be available to users of just the standard OS.

The invention provides additional advantages including, for example, allowing for faster finding of services associated with particular processes. For example, when the executable “lsass.exe” is consuming 90% of the CPU and increasing amounts of memory, the invention allows the user to quickly finding out that the services associated with this process are “Kerberos Key Distribution Center”, “IPSEC Policy Agent”, and “Security Accounts Manager”. Some of these services may be stoppable, and the user is then able to obtain a much clearer idea of what service is actually taking up the system resources. From an administrative standpoint, an administrator is able to obtain more information about the system. Additionally, this additional information can be utilized by a developer to debug a problem with the system and/or the application.

It is important to note that while the present invention has been described in the context of a fully functional data processing system, those skilled in the art will appreciate that the mechanism of the present invention is capable of being distributed in the form of a computer readable medium of instructions in a variety of forms, and that the present invention applies equally, regardless of the particular type of signal bearing media utilized to actually carry out the distribution. Examples of computer readable media include: nonvolatile, hard-coded type media such as Read Only Memories (ROMs) or Erasable, Electrically Programmable Read Only Memories (EEPROMs), recordable type media such as floppy disks, hard disk drives and CD-ROMs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

1. In a data processing system having a processor and a memory, and executing a plurality of program applications, a method for providing service level support during task management, said method comprising:
enabling selection of a services option within a pull down menu list associated with a selected process displayed within a task manager;
displaying a list of executing services associated with said process when said services option is selected; and
opening a properties window with parameters and selectable functions associated with one of said list of services that is selected, wherein a user is provided the option to stop the selected service.

2. The method of claim 1, further comprising stopping an execution of the selected service in response to a user-selection of a stop option within said properties window.

3. The method of claim 1, wherein said displaying step comprises displaying said list with display names of said services.

4. The method of claim 3, wherein said displaying step comprises opening a services window that comprises said display names along with other attributes and parameters of each of said services.

5. The method of claim 4, wherein said displaying step includes displaying only services associated with an identification (ID) of said selected process selected within said services window.

6. The method of claim 1, further comprising:
initiating a background query to identify each of said list of services that are associated with said process, wherein said query generates said display of said list of services.

7. A computer program product for utilization in a data processing system having a processor and a memory, and executing a plurality of program applications, said computer program product comprising:
a computable readable medium; and
program code on said computer readable medium for providing service level support during task management, wherein an executing service associated with a displayed process within a Task manager application may be directly identified and manipulated by a user.

8. The computer program product of claim 7, said program code comprising code for:
enabling selection of a services option within a pull down menu list associated with a selected process displayed within a task manager;
displaying a list of executing services associated with said process when said services option is selected; and
opening a properties window with parameters and selectable functions associated with one of said list of services that is selected, wherein a user is provided the option to stop the selected service.

9. The computer program product of claim 7, further comprising code for stopping an execution of the selected service in response to a user-selection of a stop option within said properties window.

10. The computer program product of claim 8, wherein said code for displaying comprises code for displaying said list with display names of said services.

11. The computer program product of claim 10, wherein said code for displaying comprises code for opening a services window that comprises said display names along with other attributes and parameters of each of said services.

12. The computer program product of claim 11, wherein said code for displaying includes code for displaying only services associated with an identification (ID) of said selected process selected within said services window.

13. The computer program product of claim 7, further comprising code for initiating a background query to identify each of said list of services that are associated with said process, wherein said query generates said display of said list of services.

14. The computer program product of claim 13, wherein code for initiating said background query includes code for:
opening and displaying a services query graphical user interface (GUI) with an entry point for receiving user-input of a process ID (PID);
returning a list of said services associated with said PID when said PID is entered into said services query GUI.

15. The computer program product of claim 14, further comprising code for opening a services window with a display of actual display names of each of said list of services.

16. The computer program product of claim 15, wherein said code for opening said services window includes code for:
providing within said services window additional parameters and attributes associated with each of said services; and
enabling an opening of a properties window with properties affiliated with a selected one of said services, wherein said properties window includes a stop option for stopping an execution of said selected service.

17. In a data processing system having a processor and a memory, and executing a plurality of program applications, a system for providing service level support during task management, said system comprising:
program means for opening and displaying a services query graphical user interface (GUI) with an entry point for receiving user-input of a process ID (PID); and
program means for returning a list of services associated with said PID when said PID is entered into said services query GUI.

18. The system of claim 17, further comprising program means for initiating a background query to identify each of said list of services that are associated with said process, wherein said query generates said display of said list of services.

19. The system of claim 17, further comprising program means for opening a services window with a display of actual display names of each of said list of services.

20. The system of claim 17, wherein said program means for opening said services window includes program means for:
providing within said services window additional parameters and attributes associated with each of said services; and
enabling an opening of a properties window with properties affiliated with a selected one of said services, wherein said properties window includes a stop option for stopping an execution of said selected service.
